(19) United States
(12) Patent Application Publication
(10) Pub. No.: US 2026/0050207 A1
(43) Pub. Date: Feb. 19, 2026

(54) AUTOMATED OPTICAL PROXIMITY CORRECTION FOR COMPUTATIONAL LITHOGRAPHY

(71) Applicant: NVIDIA Corporation, Santa Clara, CA (US)

(72) Inventors: Guojin Chen, Hong Kong (CN); Haoyu Yang, Round Rock, TX (US); Haoxing Ren, Austin, TX (US)

(21) Appl. No.: 18/988,639

(22) Filed: Dec. 19, 2024

Related U.S. Application Data
(60) Provisional application No. 63/682,696, filed on Aug. 13, 2024.

(51) Int. Cl. G03F 1/36; G03F 1/70; G06F 30/398; G06F 111/06

(52) U.S. Cl. CPC G03F 1/36; G03F 1/70; G06F 30/398; G06F 2111/06

(57) ABSTRACT

Systems and methods are provided for automated generation of optical proximity correction (OPC) recipes for producing photomasks for patterning semiconductor wafers, thereby improving the overall efficiency and effectiveness of computational lithography in modern semiconductor manufacturing. According to at least one embodiment, an OPC recipe is generated by a two-stage process that includes a reinforcement learning (RL) stage, for generating OPC actions for representative design patterns, and a large language model (LLM) stage, for generating an OPC recipe based on the OPC actions provided by the RL stage.

### CLAIM OF PRIORITY

This application claims the benefit of U.S. Provisional Application No. 63/682,696, titled “Intelligent OPC Engineer Assistant” and filed Aug. 13, 2024, the entire contents of which are incorporated herein by reference.

### BACKGROUND

As semiconductor device geometries shrink to the nanometer scale and integrated circuit layouts become increasingly complex, the limitations of traditional optical lithography have become apparent and advanced computational techniques have become necessary to achieve the required precision. Optical proximity correction (OPC) is a critical component of computational lithography. OPC systematically adjusts mask design to counteract optical proximity effects (OPE) that emerge from diffraction and interference during the photolithographic process, thereby ensuring the final printed patterns on the wafer match the intended design with high fidelity. The integration of computational lithography and OPC is crucial for advanced semiconductor devices, enabling manufacture of increasingly smaller and more complex integrated circuits while simultaneously maintaining performance, yield, and reliability.

A complete OPC solution comprises both an OPC engine and an OPC recipe. The OPC engine generates, based on an intended chip layout and the OPC recipe, an optimized chip layout for manufacture. The OPC engine includes core OPC algorithms, such as lithography imaging computation, mask database management, gradient calculation, and shape perturbation. Foundries and Electronic Design Automation (EDA) vendors typically utilize proprietary OPC engines built on advanced algorithms. The OPC recipe provides specialized rules tailored for unique chip design patterns that cannot be effectively addressed through standard optimization settings. OPC recipes typically include optimization parameters such as step size, maximum iterations, shape movement constraints, polygon fragmentation policies, and error control strategies. These specialized rules are crucial for OPC and are typically developed by experienced OPC engineers via extensive trial and error.

### BRIEF DESCRIPTION OF THE DRAWINGS

The present systems and methods are described in detail below with reference to the attached drawing figures, wherein:

FIG. 1 illustrates a block diagram of a system, according to an embodiment, for automated generation of optical proximity correction (OPC) recipes;

FIG. 2A illustrates a photolithography process for integrated circuit fabrication;

FIGS. 2B through 2E illustrate optimized OPC actions in the form of polygon fragmentation and edge placement error (EPE) measurement point selection;

FIG. 2F illustrates a full-chip layout and an exploded view of a patch, which includes a representative design pattern, selected from the full-chip layout;

FIG. 2G illustrates a portion of an example feature pool;

FIG. 2H illustrates feature labeling for two EPE points;

FIG. 2I illustrates an example decision tree for use in generating an OPC recipe;

FIG. 2J illustrates a ranking of features to be included in a decision tree by order of importance;

FIGS. 2K and 2L each illustrate a portion of an OPC recipe example;

FIG. 3A illustrates a flowchart of a method for automated generation of OPC recipes;

FIG. 3B illustrates a schematic diagram of an RL stage of a method for automated generation of OPC recipes;

FIG. 3C illustrates a schematic diagram of an OCP recipe generation stage of a method for automated generation of OPC recipes;

FIG. 4 illustrates an example parallel processing unit suitable for use in implementing some embodiments of the present disclosure;

FIG. 5A is a conceptual diagram of a processing system implemented using the PPU of FIG. 4, suitable for use in implementing some embodiments of the present disclosure;

FIG. 5B illustrates an exemplary system in which the various architecture and/or functionality of the various previous embodiments may be implemented;

FIG. 5C illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

The present disclosure provides systems and methods for automated generation of optical proximity correction (OPC) recipes, thereby improving the overall efficiency and effectiveness of computational lithography in modern semiconductor manufacturing. OPC recipes include specific configurations tailored to optimize a particular integrated circuit (IC) design, and include common optimization parameters such as step size, maximum iterations, shape movement constraints, polygon fragmentation policies, and error control strategies. OPC recipes also incorporate specialized rules for handling unique IC design patterns that cannot be effectively addressed through standard optimization settings.

According to various embodiments, systems of the present disclosure provide for automated generation of optical proximity correction (OPC) recipes via a framework that includes a reinforcement learning (RL) agent and a multi-modality large language model (MLLM)-backboned agent system to facilitate spatial reasoning and OPC recipe summarization. The MLLM-backboned agent system includes an LLM-based module for generating a decision tree that prescribes, for each respective fragment point and/or EPE measurement point of a design pattern, an OPC action corresponding to a combination of features of the respective fragment point and/or EPE measurement point. In at least one embodiment, the RL agent is trained, using proximal policy optimization (PPO), to generate OPC actions for a representative design pattern that facilitate design, by an OPC engine, of a photomask suitable for high-fidelity lithographic reproduction of the representative design pattern. In at least one embodiment, the RL agent is trained using an OPC loss that compares a result of a lithography simulation to a representative design pattern. In at least one embodiment, the LLM-based module is configured to receive the OPC actions generated by the RL agent, to generate a feature pool for fragment points/fragments and EPE measurement points, to provide labels for each fragment point/fragment and EPE measurement point for which an OPC action was generated by the RL agent, and to construct a decision tree using labeled fragment points/fragments and labeled EPE measurement points. The decision tree prescribes OPC actions for fragment points/fragments/EPE measurement points having particular combinations of identified features. In at least one embodiment, the LLM-based module is further configured to generate an OPC recipe using the decision tree.

According to various embodiments, methods of the present disclosure generate an OPC recipe via a two-stage framework. In the first stage, a reinforcement learning (RL) process is conducted to explore, for a representative design pattern, optimal OPC actions for fragmentation and EPE measurement. In the second stage, large language models (LLMs) utilize the OPC actions generated by the RL process. Initially, the LLMs generate a relevant feature pool layout and annotate each fragment point/fragment and EPE measurement point with its corresponding features. This annotated data is then used in conjunction with the OPC actions themselves to construct a decision tree. The LLMs utilize the decision tree to generate an OPC recipe.

Systems and methods of the present disclosure improve the overall efficiency and effectiveness of computational lithography in modern semiconductor manufacturing, decreasing both (i) the time between the date on which a new chip design is finalized and date on which fabrication of the new chip design can begin and (ii) the total cost required for production of chips. Experimental results have demonstrated that optimizing fragment points and EPE measurement points according to an embodiment of the present disclosure provided a more than 10% reduction in key error metrics (including edge placement error and process variation band) without increasing runtime, thereby streamlining the OPC recipe development process by eliminating time-consuming and labor intensive aspects thereof.

According to a first aspect, the present disclosure provides a computer-implemented method for automated generation of an optical proximity correction (OPC) recipe for producing a photomask for patterning a semiconductor wafer. The method includes generating, via a trained reinforcement learning (RL) agent, OPC actions for a chip design template. The OPC actions specify movement of template fragment points and/or template edge placement error (EPE) measurement points. The chip design template includes design patterns representative of a full-chip design. The method further includes constructing, via an LLM module and based on the OPC actions for the chip design template, a decision tree data structure specifying, for fragment points and EPE measurement points having a respective combination of design pattern features, a respective OPC action corresponding to the respective combination of design pattern features. The method additionally includes generating, based on the decision tree, the OPC recipe for producing the photomask for patterning the semiconductor wafer.

In at least one embodiment, constructing the decision tree data structure includes extracting, for each of a plurality of the template fragment points and/or the template EPE measurement points, design pattern features, aggregating the design pattern features to form a feature pool, and constructing, based on the feature pool and the OPC actions for the chip design template, the decision tree data structure. In at least one embodiment, constructing the decision tree data structure further comprises pruning inactive nodes from the decision tree.

In at least one embodiment, the design pattern features include point location and local design pattern geometry. The local design pattern geometry includes one or more of a pattern shape, a pattern position, a surrounding pattern characteristic, and/or a layer number.

In at least one embodiment, the method further includes converting the OPC actions for the chip design template to a combination of a JavaScript Object Notation (JSON) data structure and an image data structure.

In at least one embodiment, the respective OPC action corresponding to the respective combination of design pattern features specified by the decision tree data structure are one of a plurality of classes of quantized movement vectors.

In at least one embodiment, the RL agent is trained via a proximal policy optimization (PPO) algorithm. In at least one embodiment, the PPO algorithm trains the RL agent to maximize an expected cumulative reward derived from an OPC loss.

In at least one embodiment, the the OPC loss quantifies alignment between simulated, post-lithography semiconductor wafer patterns and the design patterns included in the chip design template. The simulated, post-lithography semiconductor wafer patterns are produced by a simulation utilizing a photomask designed using OPC actions generated by the RL agent during training. The OPC loss is computed based on (i) a Euclidean distance metric, (ii) an edge placement error (EPE), and (iii) a process variation band.

In at least one embodiment, the RL agent is trained via a process that includes receiving, by the RL agent, a training design pattern, performing, by the RL agent in accordance with a current RL agent policy, actions to adjust a position of one or more training fragment points and/or a position of one or more training EPE measurement points over a number of steps in a time horizon, calculating, by the PPO algorithm, advantage estimates for each action performed by the RL agent during the time horizon, and updating, based on the actions and the corresponding calculated advantage estimates, the RL agent policy.

According to a second aspect, the present disclosure provides a system for automated generation of an optical proximity correction (OPC) recipe for producing a photomask for patterning a semiconductor wafer. The system includes processing circuitry configured to generate, by an RL agent, OPC actions for a chip design template. The OPC actions specify movement of template fragment points and/or template edge placement error (EPE) measurement points. The chip design template includes design patterns representative of a full-chip design. The processing circuitry is further configured to construct, using a large language model (LLM) and based on the OPC actions for the chip design template, a decision tree data structure specifying, for fragment points and EPE measurement points having a respective combination of design pattern features, an OPC action corresponding to the respective combination of design pattern features. The processing circuitry is also configured to generate, based on the decision tree, the OPC recipe for producing the photomask for patterning the semiconductor wafer. The system additionally includes one or more memories configured to store the OPC recipe.

In at least one embodiment, the processing circuitry is configured to construct the decision tree data structure by extracting, for each of a plurality of the template fragment points and/or the template EPE measurement points, design pattern features, aggregating the design pattern features to form a feature pool, and constructing, based on the feature pool and the OPC actions for the chip design template, the decision tree data structure. In at least one embodiment, the processing circuitry is configured to prune inactive nodes from the decision tree data structure.

In at least one embodiment, the design pattern features include point location and local design pattern geometry, wherein the local design pattern geometry includes one or more of a pattern shape, a pattern position, a surrounding pattern characteristic, and/or a layer number.

In at least one embodiment, the processing circuitry is configured to convert the OPC actions for the chip design template to a combination of a JavaScript Object Notation (JSON) data structure and an image data structure.

In at least one embodiment, the RL agent is trained via a proximal policy optimization (PPO) algorithm configured to maximize an expected cumulative reward derived from an OPC loss; the OPC loss quantifies alignment between simulated, post-lithography wafer patterns and the design patterns included in the chip design template, the simulated, post-lithography wafer patterns produced by a simulation utilizing a photomask designed using OPC actions generated by the RL agent during training; and the OPC loss is computed based on (i) a Euclidean distance metric, (ii) an edge placement error (EPE), and (iii) a process variation band.

In at least one embodiment, the RL agent is trained via a process that includes receiving, by the RL agent, a training design pattern, performing, by the RL agent in accordance with a current RL agent policy, actions to adjust a position of one or more training fragment points and/or a position of one or more training EPE measurement points over a number of steps in a time horizon, calculating, by the PPO algorithm, advantage estimates for each action performed by the RL agent during the time horizon, and updating, based on the actions and the corresponding calculated advantage estimates, the RL agent policy.

According to a third aspect, the present disclosure provides a non-transitory computer readable medium having stored thereon processor executable instructions that, when executed by processing circuitry, cause the processing circuitry to perform the method according to the first aspect and any embodiment thereof.

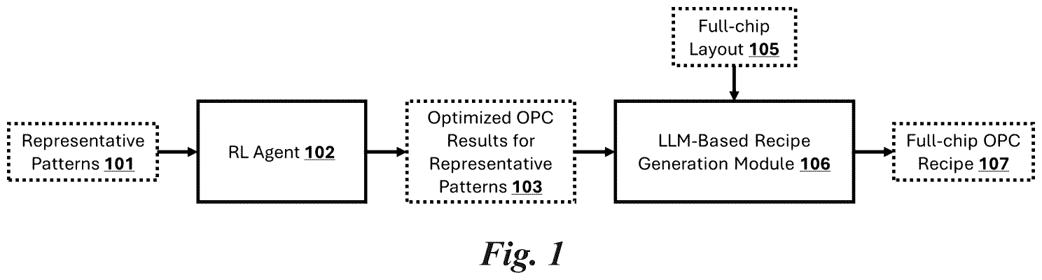

FIG. 1 illustrates a block diagram of a system 100, according to an embodiment, for automated generation of optical proximity correction (OPC) recipes. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 100 is within the scope and spirit of embodiments of the present disclosure.

The system 100 includes a trained reinforcement learning (RL) agent 102 and a large language model (LLM)-based recipe generation module 106. The trained RL agent 102 is configured to receive, as input, one or more representative design patterns 101. The representative design patterns provide target, post-lithography design geometries that are representative of design geometries included in a full-chip layout 105. The trained RL agent 102 is also configured to generate, as output, a set of OPC results 103 tailored to specific features of the target, post-lithography geometries provided in the one or more representative design patterns. In at least one embodiment, the set of OPC results 103 includes, for each of one or more patches of a chip layout, results of fragmentation and of edge placement error (EPE) measurement point selection for the design pattens included in the one or more patches. The LLM-based module 106 is configured to efficiently derive, based on the set of OPC results 103 output by the RL agent 102 and the full-chip layout 105, a comprehensive OPC recipe for the full-chip layout. The LLM-based module 106 derives the comprehensive OPC recipe for the full-chip layout 105 by (i) deriving, using the set of OPC results 103 output by the RL agent 102, rules for handling corrections for specific features of design patterns and (ii) applying the derived rules to the design patterns included in the full-chip layout 105.

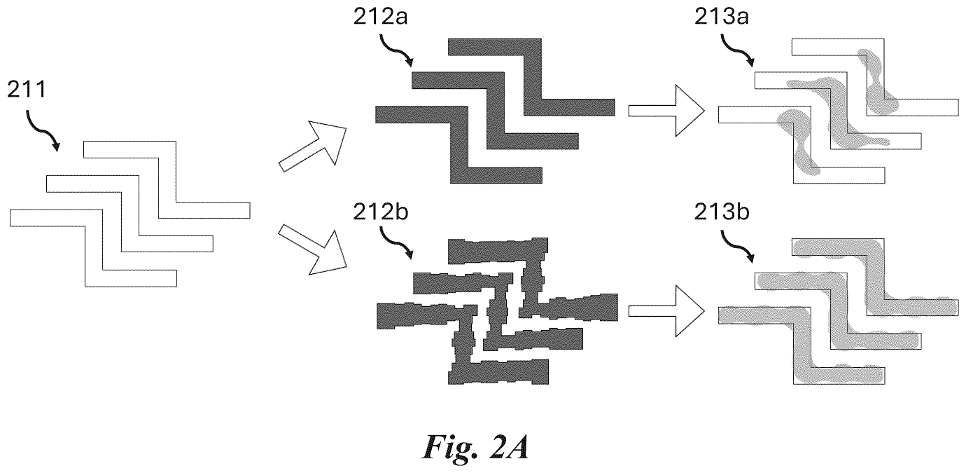

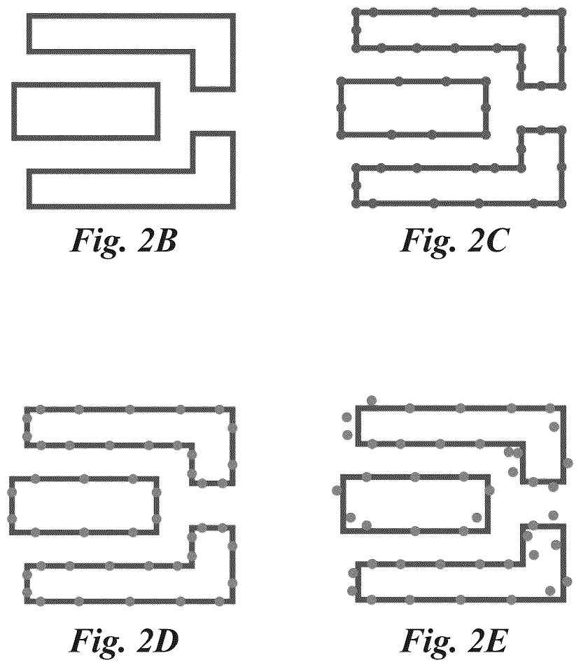

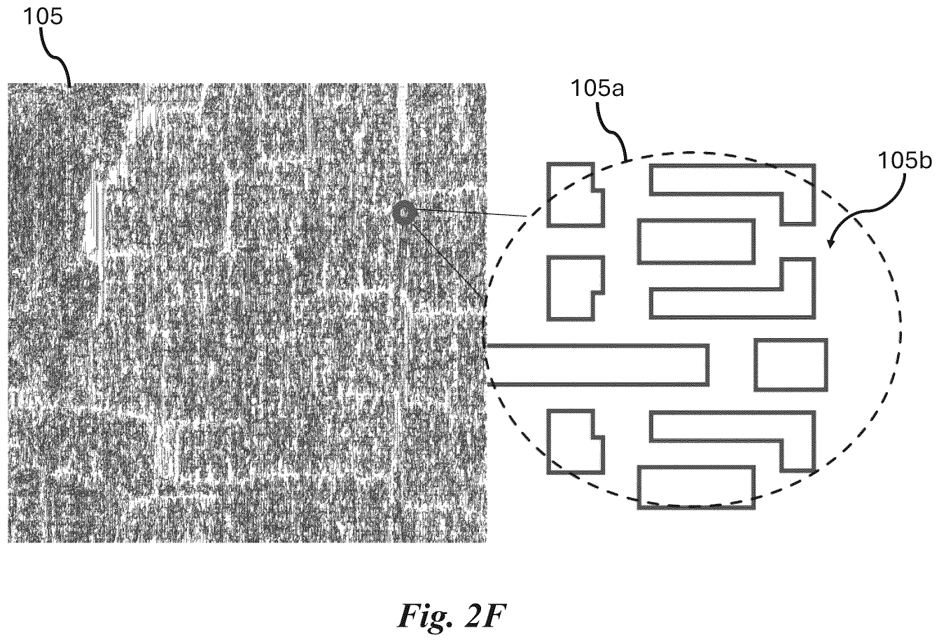

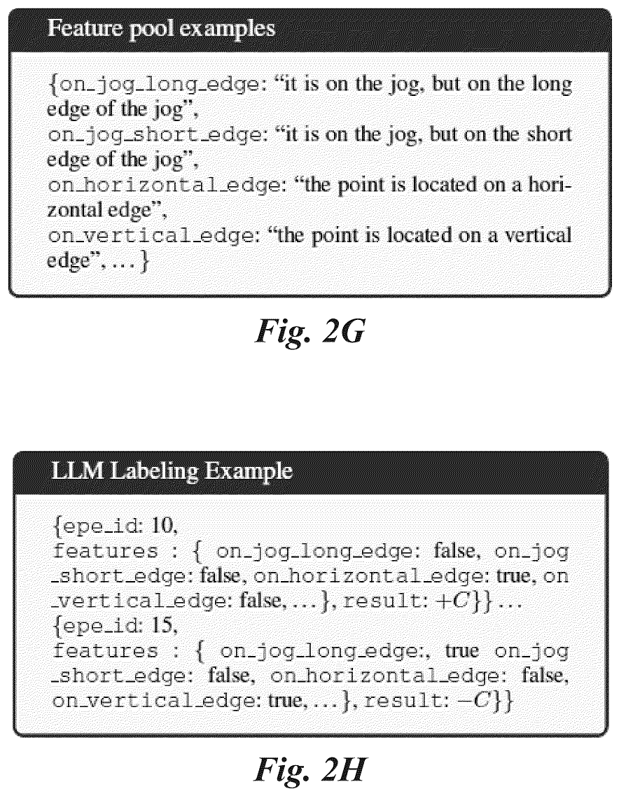

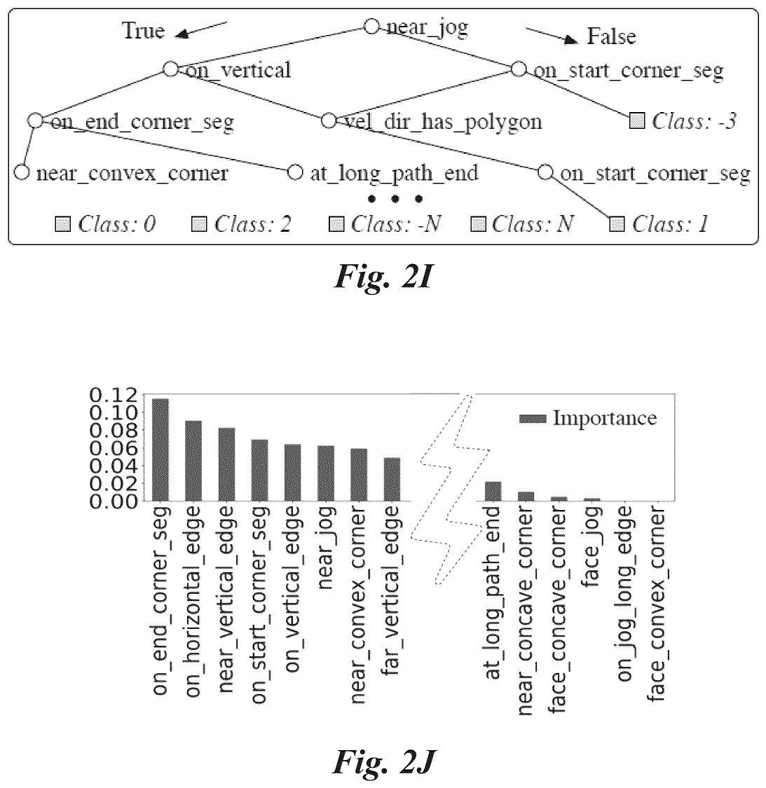

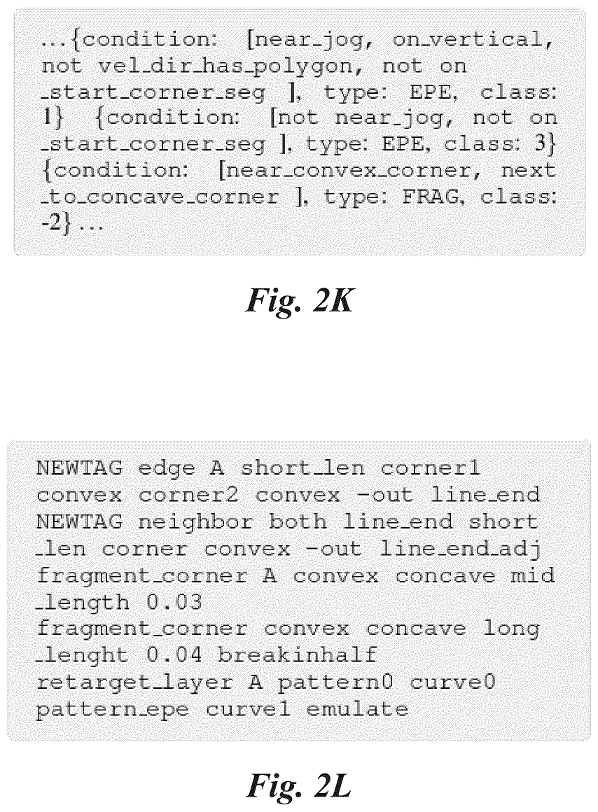

FIG. 2A illustrates a photolithography process for integrated circuit fabrication. The photolithography process transfers a design pattern (i.e. a target, post-lithography geometry) 211 onto a semiconductor wafer. In order to do so, the photolithography process employs a photomask, which allows light to pass through and contact a specified region of the semiconductor wafer, thereby forming the design pattern thereon. As device geometries shrink to the nanometer scale, the limitations of traditional optical lithography become apparent, necessitating advanced computational methods to achieve the desired fidelity. OPC is a critical component of computational lithography, addressing distortions and proximity effects that arise during the lithographic process. By systematically adjusting the mask design to counteract these effects, OPC ensures that the final printed patterns on the wafer closely match the intended design-which is important for maintaining device performance, yield, and reliability in the semiconductor industry.

FIG. 2A illustrates two photomasks: photomask 212a, which is formed with OPC, and photomask 212b, which is formed without OPC. Photomask 212a has a geometry that is identical to that of design pattern 211, which photomask 212b has a geometry that has been systematically adjusted to counteract optical proximity effects (OPE) that emerge from diffraction and interference during the photolithographic process. FIG. 2A also illustrates printed wafer geometry 213a, which results from a photolithographic process using the photomask 212a, and printed wafer geometry 213b, which results from a photolithographic process using the photomask 212b. As can be seen from a comparison of printed wafer geometries 213a and 213b, OPC ensures that printed wafer geometry 213b closely matches design pattern 211.

The RL agent 102 is trained to provide OPC results (e.g. polygon fragmentation and edge placement error (EPE) measurement point selection) that, when provided to an OPC engine, yield a photomask design that improves the precision and efficiency of lithographic patterning. In at least one embodiment, the RL agent 102 is trained via an OPC loss that quantifies the alignment between a post-lithography design produced by a given mask design and a target design. In at least one embodiment, the OPC loss is computed based on (i) a Euclidean distance metric (which measures the Euclidean distance between the post-lithography design and the target design), (ii) an edge placement error (EPE), and (iii) the process variation band.

According to at least one embodiment, the RL agent 102 receives, as input during training, a target design pattern that includes polygon coordinates and/or corresponding rasterized images. The RL agent policy is optimized over a number of training epochs. During each training epoch, the current policy of the RL agent 102 is used to generate OPC results (e.g. a set of fragment points and EPE measurement points for the target design pattern received as input) for the target design received as input. In at least one embodiment, the OPC results for the target design are the result of adjustments, over a number of steps t=0, 1, . . . , T in a time horizon, of positions of fragment points and EPE measurement points. The adjustments are provided with respect to initial fragment points and EPE measurement points determined in accordance with standard rules used as a baseline. In at least one embodiment, the standard rules perform initial fragmentation by evenly splitting polygon edges and setting the midpoint of each resulting fragment as an EPE measurement point. Also during each training epoch, the OPC results generated by the current policy of the RL agent 102 are provided as input to an OPC engine (e.g. an OPC solver implementation provided by a foundry or an electronic design automation (EDA) vendor), the OPC engine generates a photomask based on the OPC results provided as input, a lithography simulation is performed using the generated photomask, an OPC loss is computed based on the results of the lithography simulation (e.g. by measuring differences between the target design pattern and a simulated wafer pattern), and the RL agent policy is updated based on the computed OPC loss. The RL agent policy is trained using an RL algorithm designed to explore the parameter space and conduct a global OPC optimization, customized for various design rules and scenarios. The process aims to automate the identification of effective, fine-tuned parameter combinations, thereby reducing the time and expertise needed for manual OPC recipe adjustment.

In at least one embodiment, the RL agent 102 is trained using a proximal policy optimization (PPO) algorithm. The PPO algorithm trains the RL agent 102 to maximize an expected cumulative reward derived from the OPC loss. The PPO algorithm leverages deep learning models to iteratively enhance OPC recipe development through agent-environment interactions. The environment includes the polygon space defined by polygon coordinates and their corresponding rasterized images, which serve as feature embeddings in the observation space. The PPO algorithm calculates, using the OPC loss, advantage estimates for the actions taken (e.g. adjustments, addition of new fragments, addition of new EPE measurement points) by the RL agent 102 and updates, based on the actions and their corresponding calculated advantage estimates, the RL agent policy. In at least one embodiment, the RL agent policy is a learned neural network. In at least one embodiment, the RL agent policy invokes an RL value function that is a learned neural network.

In at least one embodiment, the RL algorithm is the proximal policy optimization (PPO) algorithm, and the training of the RL agent 102 leverages deep learning models to iteratively enhance OPC recipe development through agent-environment interactions. The environment in this context includes the polygon space defined by polygon coordinates and their corresponding rasterized images, which serve as feature embeddings in the observation space. The agent, guided by PPO, learns to adjust fragment points and EPE measurement points to minimize the OPC loss function. The state of the environment at time t, denoted as sₜ, includes both the polygon coordinates and the rasterized image features. The agent takes an action at, which adjusts the positions of these points. The environment then transitions to a new state sₜ+1 and the agent receives a reward rₜ based on the OPC loss. The PPO algorithm maximizes the expected cumulative reward, defined as the return Rₜ:

$${R}_{t} = {\sum }_{k = t}^{T} {γ}^{k - t} {r}_{k} ,$$

where γ is the is the discount factor and T is the time horizon. The PPO optimizes a policy π_{θ}(αₜ|sₜ), parameterized by θ, by interacting with the environment and updating θ to maximize the expected return. The policy update is constrained by a proximity term to ensure stability:

$${ℒ}^{CLIP} ( θ ) = {𝔼}_{t} [ min ( \frac{{π}_{θ} ( {a}_{t} \vert {s}_{t} )}{{π}_{{θ}_{old}} ( {a}_{t} \vert {s}_{t} )} ) {\hat{A}}_{t} , clip ( \frac{{π}_{θ} ( {a}_{t} \vert {s}_{t} )}{{π}_{{θ}_{o l d}} ( {a}_{t} \vert {s}_{t} )} , 1 - ϵ , 1 + ϵ ) {\hat{A}}_{t} ] ,$$

where Âₜ is the advantage estimate and E is a clipping parameter. The advantage estimate Âₜ is calculated as:

$${\hat{A}}_{t} = {δ}_{t} + ( γ λ ) {δ}_{t - 1} + … + {( γ λ )}^{T - t + 1} {δ}_{T}$$

with the temporal difference error δₜ given by:

$${δ}_{t} = {r}_{t} + γ V ( {s}_{t + 1} ) - V ( {s}_{t} ) .$$

In the OPC context, the state sₜ includes the current positions of the measurement points, the fragment points, and the rasterized image features. The action αₜ consists of permissible adjustments to these points within a specified range of ±40 nm. The reward function rₜ, critical to the RL training process, is derived from the OPC [symbol] _{OPC}, which quantifies the alignment between the corrected mask pattern and the target design post-lithography. To align with the RL paradigm where higher rewards are preferred, the reward is defined as the negative of the OPC loss:

$${r}_{t} = - {ℒ}_{OPC} .$$

Mathematically, the OPC loss can be expressed as:

$${ℒ}_{OPC} = α \cdot {ℒ}_{2} ( v , z ) + β \cdot EPE ( v , z ) + γ \cdot PVB ( v , z ) ,$$

where ν represents the rasterized image representation from vertices of the polygon, z is the target pattern, [symbol] ₂ is the Euclidean distance metric. EPE and PVB are edge placement error and process variation band, respectively. The coefficients α, β, and γ are weights that balance the contributions of each term to the overall loss. The OPC loss is computed, in at least one embodiment, by measuring differences between the target design pattern and a simulated wafer pattern resulting from a lithography simulation carried out using a photomask generated based, at least in part, on an OPC recipe including OPC results generated by the RL agent 102. Additionally, the value function V(sₜ) is approximated using a neural network parameterized by ϕ, and is trained to minimize the following loss:

$${ℒ}_{V} ( ϕ ) = {𝔼}_{t} [ {V}_{ϕ} ( {s}_{t} ) - {R}_{t}^{2} ] .$$

The overall training objective combines the clipped surrogate objective for policy optimization and the value function loss, along with an entropy bonus S[π_{θ}](sₜ) to encourage exploration:

$$ℒ ( θ , ϕ ) = {𝔼}_{t} [ {L}^{CLIP} ( θ ) - {c}_{1} {L}_{V} ( ϕ ) + {c}_{2} S [ {π}_{θ} ] ( {s}_{t} ) ] ,$$

where c₁ and c₂ are coefficients that balance the importance of the value loss and the entropy bonus, respectively.

FIGS. 2B through 2E illustrate optimized OPC results in the form of polygon fragmentation and edge placement error (EPE) measurement point selection. Specifically, for the representative design pattern illustrated in FIG. 2B (e.g. a portion of the representative patterns 101 received by the RL agent 102 in FIG. 1), FIGS. 2C and 2E provide OPC results (e.g. a portion of the set of OPC results 103 generated by RL agent 102 in FIG. 1), in the form of polygon fragmentation (FIG. 2C provides a fragmented design pattern corresponding to the design pattern of FIG. 2B) and of edge placement error (EPE) measurement point selection (FIG. 2E provides EPE measurement adjusted from the default EPE measurement points of FIG. 2D, which are located at the midpoints of the polygon fragments of FIG. 2C).

The LLM-based module 106 includes a multi-modal large language model (MLLM)-based feature agent and an LLM-based summarization agent. The MLLM-based feature agent is configured to (i) generate, based on input in the form of in the OPC results 103 output by the RL agent 102, a feature pool, (ii) label each fragment point/EPE measurement point (in the OPC results 103) as having or not having various features in the feature pool, thereby generating a feature set for each fragment point/EPE measurement point, and (iii) construct a decision tree, based on the labeled fragment point/EPE measurement points, that maps an OPC action to respective fragment points/EPE measurement points based on a feature set possessed by the respective fragment point/EPE measurement point. The feature pool, which is generated by the MLLM, includes a list of various features that may or may not be present in a particular fragment point/EPE measurement point. The Decision tree includes, for each combination of features that a fragment point/EPE measurement point has, an action to be applied to that point for generation of an OPC recipe. Once the decision tree has been constructed, each branch serves as a reference that can be used by the LLM-based summarization agent to generate the full-chip OPC recipe 107 for the full-chip layout 105. The full-chip OPC recipe can be used to produce a photomask, which allows light to pass through and pattern a semiconductor wafer by contacting a specified region thereof, for a photolithography process for transfering a design pattern (i.e. a target, post-lithography geometry) onto the semiconductor wafer.

FIG. 2F illustrates the full-chip layout 105 and an exploded view of a patch 105a selected from the full-chip layout 105. The patch 105a includes a number of polygons that form a design pattern 105b. In at least one embodiment, the design pattern 105b is utilized as a representative pattern of the representative patterns 101. The LLM-based module 106 processes the OPC results 103 output by the RL agent 102 to generate the full-chip OPC recipe 107 for the full-chip layout 105.

The LLM-based module 106 leverages the capabilities of LLMs (e.g. advanced natural language processing capabilities, summarizing, and reasoning) to summarize the OPC results output by the RL agent 102 and to derive effective and generalizable OPC recipe rules for constructing the full-chip OPC recipe 107 for the full-chip layout 105. While the process of training the RL agent 102 to generate OPC results and using the trained RL agent to generate OPC results for representative design patterns (e.g. those included in a small patch of the full-chip layout 105) produces good results, significant challenges arise when attempting to apply that process to full-chip scenarios. In particular, to the need to process millions of clips leads to an impractically long runtime for RL. Additionally, in OPC recipe development, the final step requires the extraction of recipe rules based on pattern shapes, which are then used by commercial OPC software for pattern matching and retargeting operations.

The LLM-based module 106 leverages the capabilities of multimodal large models to bridge the gap between superior RL exploration outcomes and the generation of OPC recipes. To address hallucination issues often associated with LLMs, the LLM-based module 106 is, according to at least one embodiment, configured to generate the full-chip OPC recipe 107 for the full-chip layout 105 via a four phase process. First, during a data processing phase, the OPC results generated by the RL agent 102 are converted into two distinct formats: JavaScript Object Notation (JSON) and image clips. Second, during a feature pool generation phase, the MLLM agent performs feature generation and zeroshot data labeling. Third, during a decision tree construction phase, a decision tree is constructed based on the labeled features. And fourth, during an OPC recipe generation phase, the decision tree serves as a retrieval source for the LLM-based summarization agent, facilitating the generation of the full-chip OPC recipe. This structured methodology ensures the effective translation of RL exploration results into a practical OPC recipe, enhancing the overall efficiency and accuracy of the recipe generation process. In contrast to the foregoing structured methodology, feeding OPC results generated by the RL agent 102 directly into an LLM as coordinates of segments presents two major issues. First, an LLM cannot comprehend the spatial relationships between edges or polygons based solely on coordinates, and second, due to the limitations of the LLM's context window, it cannot process exceedingly long coordinate representations, leading to judgments based only on the first few points, often resulting in incorrect assessments. Accordingly, the structured methodology according to at least one embodiment of the present disclosure contributes to reducing key error metrics and creating optimized OPC recipes with improved accuracy and reliability, thereby providing improvements to the domain of computational lithography through the integration of advanced computational techniques.

In at least one embodiment, during the first data processing phase, the OPC results generated by the RL agent 102 are transformed into JSON and image clip data structures. As the RL action space provides for EPE measurement point movement and edge fragment point movement, the data structure can be uniformly represented in two major parts. The first part indicates whether the point's movement direction aligns with the positive direction, and the second part specifies the exact movement distance. This structured representation ensures that the RL-optimized layout information is effectively retained and utilized in OPC recipe development. In at least one embodiment, for each point eᵢ, the RL-adjusted movement vector δ is recorded with normal direction i and the distance 6. Converting the data into JSON format facilitates the LLM's understanding of the RL results.

In at least one embodiment, during the feature pool generation phase, the “optimization algorithm” embedded in the OPC results generated by the RL agent 102 is explicitly expressed via zero-shot feature pool generation and data labeling. To maximally preserve the layout information optimized by the RL agent 102, the information is first transcribed to record location-related details and geometry features for each point. For example, each EPE measurement point and fragment point is labeled with a set of location-related details and geometry features including, e.g, pattern shape, position, surrounding pattern characteristics, and layer number.

In at least one embodiment, the MLLM-based feature agent performs classification labeling for the OPC results generated by the RL agent via a two-step process. The first step involves feature mining and generation, while the second step involves feature labeling. During feature mining and generation, images of EPE points and fragment points (e.g. the image clip data structures into which the OPC results generated by the RL agent 102 are transformed) are input into the MLLM-based feature agent, which analyzes the images and extracts features. For different points, the features generated by the MLLM-based feature agent are pooled and deduplicated. The data format includes feature names and descriptions, resulting in a comprehensive feature pool. FIG. 2G illustrates a portion of an example feature pool. During feature labeling, the feature pool generated by the MLLM-based feature agent in the first step is used for labeling each EPE measurement point and fragment point in the second step. As a result of the feature labeling, a series of feature information is provided for each EPE point and fragment point. FIG. 2H illustrates feature labeling for two EPE points. In this manner, intricate details of the RL-optimized layouts are preserved and the OPC recipe development process is streamlined, making it more efficient and effective.

In at least one embodiment, during the decision tree construction phase, the feature sets for the fragment points/EPE measurement points, combined with the OPC results provided for the fragment points/EPE measurement points (e.g. as indicated in the JSON and image clip data structures) are used to construct a decision tree. The decision tree for each design pattern is constructed via combining the original polygon information with the extracted features. Based on the results from the first RL phase, each leaf node of the decision tree is labeled with a corresponding recipe type. Once the decision tree is constructed, each branch serves as a reference for the LLM to write corresponding OPC rules, which can be used to generate a complete OPC recipe. In at least one embodiment, to ensure the decision tree and ultimate OPC recipe do not become overly complicated, the RL-movement vector δ is, in at least one embodiment, divided into different intervals that serve as classification boundaries. For example, in a given direction, the vector δ is categorized into C intervals, where the furthest positive interval is labeled as +C and the furthest negative interval as −C. Consequently, ground truth labels in the decision tree range from −C to +C, encompassing a total of 2C+1 classes. A label of 0 indicates no movement. FIG. 2I illustrates an example decision tree according to at least one embodiment. The decision tree provides, for different combinations of features possessed by fragment points/EPE measurement points, a class corresponding to an OPC action (e.g. an OPC action taken to provide the OPC results 103 output by the RL agent 102).

In at least one embodiment, the features are be ranked by importance and importance-based feature selection is performed. FIG. 2J illustrates a ranking of features by order of importance, in which features “on jog long edge” and “face convex corner” rank the lowest, with a feature importance of 0. In at least one embodiment, unimportant features are removed and recycled back into the LLM's input (e.g. by providing a query to the LLM-based agent identifying the features, indicating they are unimportant, and instructing that they be removed), enhancing feature extraction and development and thereby iteratively updating the feature pool and the decision tree.

In at least one embodiment, during the OPC recipe generation phase, the decision tree serves as a retrieval source for the LLM-based summarization agent, which utilizes the decision tree to generate the full-chip OPC recipe. FIG. 2K illustrates, according to an embodiment, a portion of an OPC recipe example in JSON format in which conditions are decision tree feature labels, types determine a task (e.g. EPE measurement point selection, fragmentation), and the class corresponds to an OPC action to take (e.g. a movement of an EPE measurement point or fragment point). FIG. 2L illustrates, according to an embodiment, a portion of an OPC recipe example, in Tcl language, that includes statements for defining feature labels and movement distances.

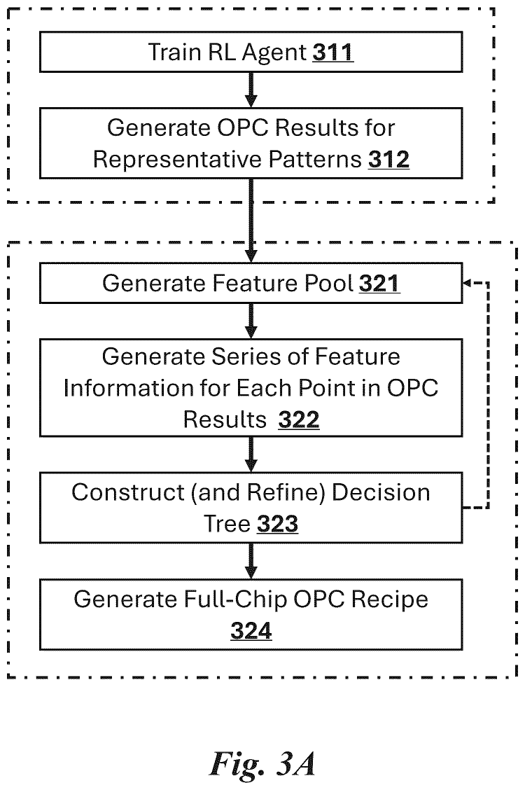

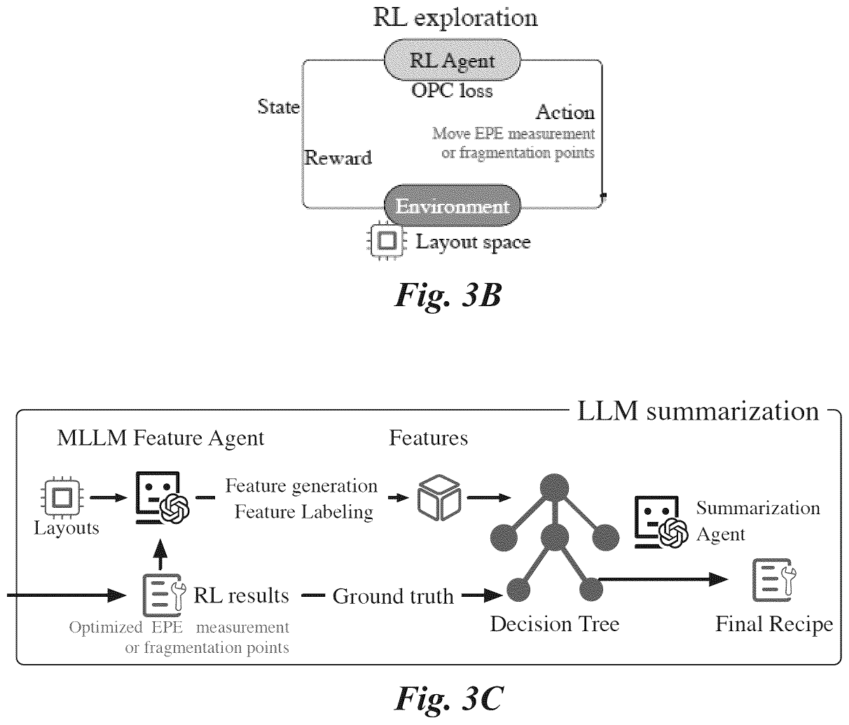

FIG. 3A illustrates a flowchart of a method 300 for automated generation of optical proximity correction (OPC) recipes, in accordance with an embodiment. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

The method 300 includes a reinforcement learning (RL) stage 310 and an OPC recipe generation stage 320. In various embodiments, the RL stage 310 is performed by the RL agent 102 and includes performing one or more actions discussed above with respect to the system of FIG. 1. The process the reinforcement learning (RL) stage 310 includes, at 311, training an RL agent to generate OPC results for a design pattern provided as input. In at least one embodiment, the RL agent is trained using the PPO algorithm discussed above. The RL phase 310 additionally includes, at 312, generating OPC results for one or more representative design patterns. In at least one embodiment, the OPC results include providing optimized fragmentation points and EPE measurement points the one or more representative design patterns. The OPC results are provided as input to an LLM-based module configured to implement the OPC recipe generation stage 320. In various embodiments, the OPC recipe generation stage 320 is performed by the RL agent 102 and includes performing one or more actions discussed above with respect to the system of FIG. 1.

The OPC recipe generation stage 320 includes, at 321, generating a feature pool by extracting features of a plurality of fragment points/EPE measurement points provided in the OPC results generated at 312. The OPC recipe generation stage 320 further includes, at 322, generating a series of feature information for each fragment point/EPE measurement point in the OPC results generated at 312, and, at 323, constructing and refining a decision tree. The decision tree is constructed based on the series of feature information for the fragment points/EPE measurement points and provides, for every respective combination of features, a branch that ends in a leaf node specifying an action to take (e.g. a movement vector, e.g. corresponding to a defined class), during the generation of an OPC recipe, for a fragment point/EPE measurement point that has the respective combination of features. In at least one embodiment, the decision tree is constructed using a Python library framework. In at least one embodiment, 323 further includes refining the decision tree. Refining the decision tree can include pruning nodes for unimportant features (i.e. based on a feature importance ranking) and repeating 321-323 in an iterative manner to enhance feature extraction and development. Once the decision tree is constructed and refined, the OPC recipe generation stage 320 utilizes the decision tree constructed at 323 to generate, at 321, one or more full-chip recipes. The full-chip recipes are generated at 321 by determining, for every respective fragment point/EPE measurement point in the full-chip design, a combination of features the respective point has, identifying a branch in the decision tree corresponding to that same combination of features, and performing an action prescribed by the identified branch.

FIG. 3B illustrates a schematic diagram of the RL stage 310 according to at least one embodiment. In the embodiment illustrated in FIG. 3B, the RL stage 310 involves performing RL exploration of an action space comprising EPE measurement point and fragmentation point movement within an environment that includes polygons of a representative design pattern provided as input (the layout space). The actions result in a modification of the state of the environment, and a reward function is used to train the RL agent by providing rewards corresponding to the actions. The RL agent is trained to provide optimized OPC results that include, for a representative design pattern, optimized EPE measurement points and optimized fragmentation points for the polygons included in the representative design pattern.

FIG. 3C illustrates a schematic diagram of the OPC recipe generation stage 320 according to at least one embodiment. In the embodiment illustrated in FIG. 3C, the OPC recipe generation stage 320 receives the optimized EPE measurement points and optimized fragmentation points from the RL stage 310 and performs, by an MLLM feature agent, feature generation and feature labeling to provide a feature pool and a collection of labeled EPE measurement points and labeled fragmentation points/fragments. A decision tree is constructed from the labeled EPE measurement points and the labeled fragmentation points/fragments, and a final OPC recipe is generated, by an LLM summarization agent, based on the decision tree.

More illustrative information will now be set forth regarding various optional architectures and features with which the aspects of the foregoing disclosure may be implemented, per the desires of the user. It should be strongly noted that the following information is set forth for illustrative purposes and should not be construed as limiting in any manner. Any of the following features may be optionally incorporated with or without the exclusion of other features described.

### Parallel Processing Architecture

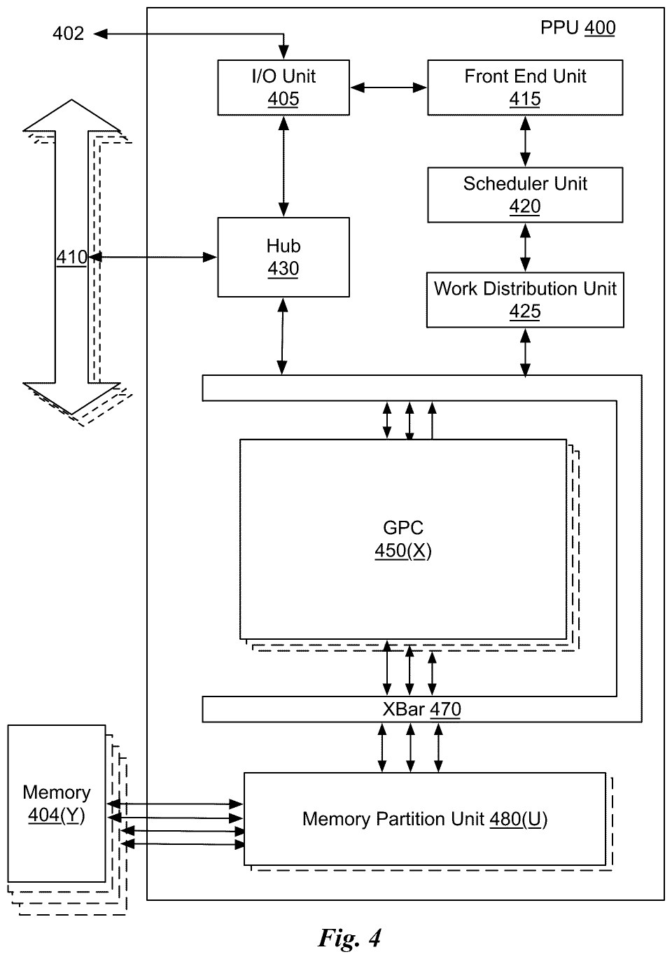

FIG. 4 illustrates a parallel processing unit (PPU) 400, in accordance with an embodiment. In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

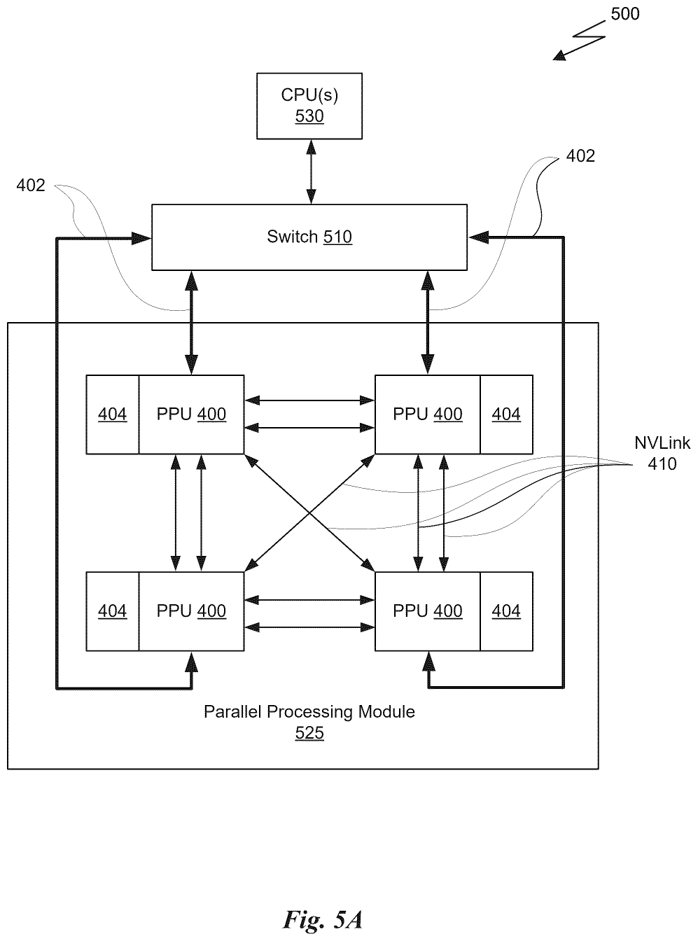

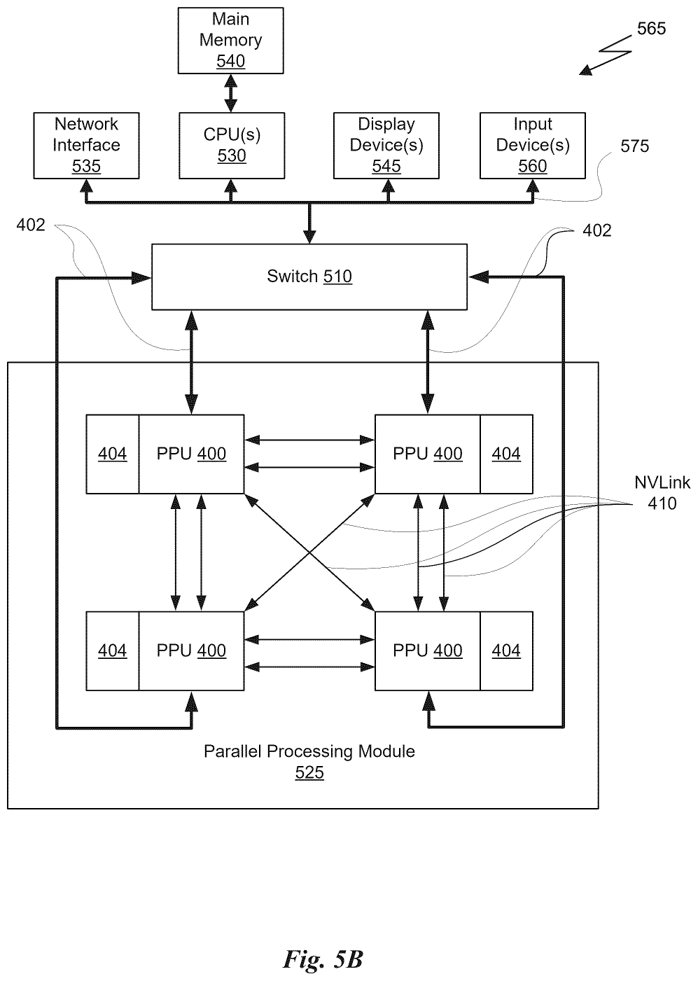

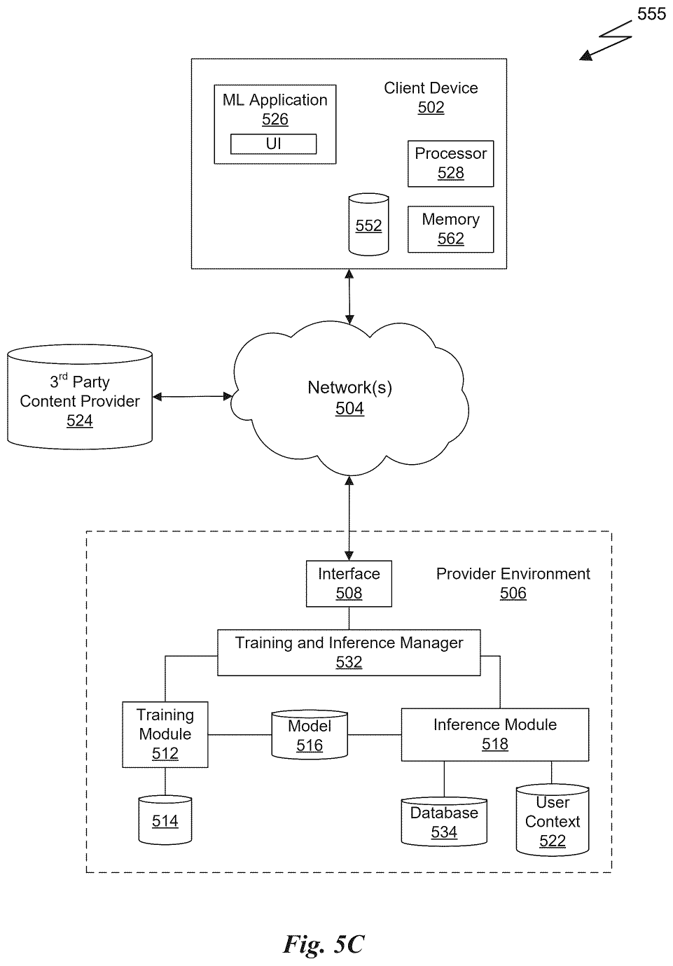

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units(TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “cclient device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Example Streaming System

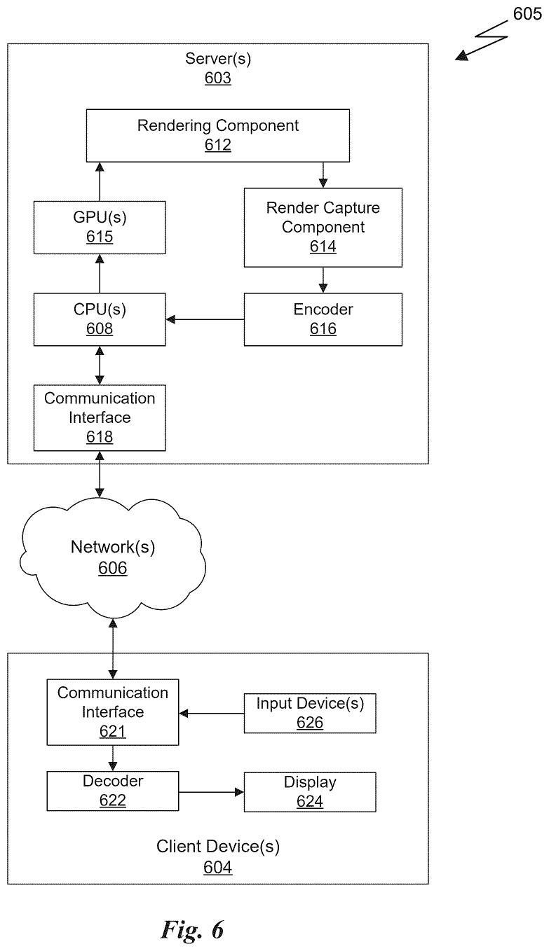

FIG. 6 is an example system diagram for a streaming system 605, in accordance with some embodiments of the present disclosure. FIG. 6B includes game server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s), transmit the input data to the game server(s) 603, receive encoded display data from the game server(s) 603, and display the display data on the display 624. As such, the more computationally intense computing and processing is offloaded to the game server(s) 603 (e.g., rendering—in particular ray or path tracing—for graphical output of the game session is executed by the GPU(s) of the game server(s) 603). In other words, the game session is streamed to the client device(s) 604 from the game server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the game server(s) 603. The client device 604 may receive an input to one of the input device(s) and generate input data in response. The client device 604 may transmit the input data to the game server(s) 603 via the communication interface 621 and over the network(s) 606 (e.g., the Internet), and the game server(s) 603 may receive the input data via the communication interface 618. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the game server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for automated generation of an optical proximity correction (OPC) recipe for producing a photomask for patterning a semiconductor wafer, the method comprising:
generating, via a trained reinforcement learning (RL) agent, OPC actions for a chip design template, the OPC actions specifying movement of template fragment points and/or template edge placement error (EPE) measurement points, the chip design template including design patterns representative of a full-chip design;
constructing, via an LLM module and based on the OPC actions for the chip design template, a decision tree data structure specifying, for fragment points and EPE measurement points having a respective combination of design pattern features, a respective OPC action corresponding to the respective combination of design pattern features; and
generating, based on the decision tree, the OPC recipe for producing the photomask for patterning the semiconductor wafer.

2. The method according to claim 1, wherein the constructing the decision tree data structure comprises:
extracting, for each of a plurality of the template fragment points and/or the template EPE measurement points, design pattern features;
aggregating the design pattern features to form a feature pool; and
constructing, based on the feature pool and the OPC actions for the chip design template, the decision tree data structure.

3. The method according to claim 2, wherein the constructing the decision tree data structure further comprises pruning inactive nodes from the decision tree.

4. The method according to claim 2, wherein the design pattern features include point location and local design pattern geometry, wherein the local design pattern geometry includes one or more of a pattern shape, a pattern position, a surrounding pattern characteristic, and/or a layer number.

5. The method according to claim 1, further comprising converting the OPC actions for the chip design template to a combination of a JavaScript Object Notation (JSON) data structure and an image data structure.

6. The method according to claim 1, wherein the respective OPC action corresponding to the respective combination of design pattern features specified by the decision tree data structure are one of a plurality of classes of quantized movement vectors.

7. The method according to claim 1, wherein the RL agent is trained via a proximal policy optimization (PPO) algorithm.

8. The method according to claim 7, wherein the PPO algorithm trains the RL agent to maximize an expected cumulative reward derived from an OPC loss.

9. The method according to claim 8, wherein the OPC loss quantifies alignment between simulated, post-lithography semiconductor wafer patterns and the design patterns included in the chip design template, the simulated, post-lithography semiconductor wafer patterns produced by a simulation utilizing a photomask designed using OPC actions generated by the RL agent during training, and
wherein the OPC loss is computed based on (i) a Euclidean distance metric, (ii) an edge placement error (EPE), and (iii) a process variation band.

10. The method according to claim 7, wherein the RL agent is trained via a process comprising:
receiving, by the RL agent, a training design pattern;
performing, by the RL agent in accordance with a current RL agent policy, actions to adjust a position of one or more training fragment points and/or a position of one or more training EPE measurement points over a number of steps in a time horizon;
calculating, by the PPO algorithm, advantage estimates for each action performed by the RL agent during the time horizon; and
updating, based on the actions and the corresponding calculated advantage estimates, the RL agent policy.

11. A system for automated generation of an optical proximity correction (OPC) recipe for producing a photomask for patterning a semiconductor wafer, the system comprising:
processing circuitry configured to:
generate, by an RL agent, OPC actions for a chip design template, the OPC actions specifying movement of template fragment points and/or template edge placement error (EPE) measurement points, the chip design template including design patterns representative of a full-chip design;
construct, using a large language model (LLM) and based on the OPC actions for the chip design template, a decision tree data structure specifying, for fragment points and EPE measurement points having a respective combination of design pattern features, an OPC action corresponding to the respective combination of design pattern features; and
generate, based on the decision tree, the OPC recipe for producing the photomask for patterning the semiconductor wafer; and
one or more memories configured to store the OPC recipe.

12. The system according to claim 11, wherein the processing circuitry is configured to construct the decision tree data structure by:
extracting, for each of a plurality of the template fragment points and/or the template EPE measurement points, design pattern features;
aggregating the design pattern features to form a feature pool; and
constructing, based on the feature pool and the OPC actions for the chip design template, the decision tree data structure.

13. The system according to claim 12, wherein the processing circuitry is configured to prune inactive nodes from the decision tree data structure.

14. The system according to claim 12, wherein the design pattern features include point location and local design pattern geometry, wherein the local design pattern geometry includes one or more of a pattern shape, a pattern position, a surrounding pattern characteristic, and/or a layer number.

15. The system according to claim 11, wherein the processing circuitry is configured to convert the OPC actions for the chip design template to a combination of a JavaScript Object Notation (JSON) data structure and an image data structure.

16. The system according to claim 11, wherein the RL agent is trained via a proximal policy optimization (PPO) algorithm configured to maximize an expected cumulative reward derived from an OPC loss, wherein the OPC loss quantifies alignment between simulated, post-lithography wafer patterns and the design patterns included in the chip design template, the simulated, post-lithography wafer patterns produced by a simulation utilizing a photomask designed using OPC actions generated by the RL agent during training, and
wherein the OPC loss is computed based on (i) a Euclidean distance metric, (ii) an edge placement error (EPE), and (iii) a process variation band.

17. The system according to claim 16, wherein the RL agent is trained via a process comprising:
receiving, by the RL agent, a training design pattern;
performing, by the RL agent in accordance with a current RL agent policy, actions to adjust a position of one or more training fragment points and/or a position of one or more training EPE measurement points over a number of steps in a time horizon;
calculating, by the PPO algorithm, advantage estimates for each action performed by the RL agent during the time horizon; and
updating, based on the actions and the corresponding calculated advantage estimates, the RL agent policy.

18. A non-transitory computer readable medium having stored thereon processor executable instructions that, when executed by processing circuitry, cause the processing circuitry to perform a method for automated generation of an optical proximity correction (OPC) recipe for producing a photomask for patterning a semiconductor wafer, the method comprising:
generating, via a trained RL agent, OPC actions for a chip design template, the OPC actions specifying movement of template fragment points and/or template edge placement error (EPE) measurement points, the chip design template including design patterns representative of a full-chip design;
constructing, via an LLM module and based on the OPC actions for the chip design template, a decision tree data structure specifying, for fragment points and EPE measurement points having a respective combination of design pattern features, a respective OPC action corresponding to the respective combination of design pattern features; and
generating, based on the decision tree, the OPC recipe for producing the photomask for patterning the semiconductor wafer.

19. The non-transitory computer readable medium according to claim 18, wherein the constructing the decision tree comprises:
extracting, for each of a plurality of the template fragment points and/or the template EPE measurement points, design pattern features;
aggregating the design pattern features to form a feature pool; and
constructing, based on the feature pool and the OPC actions for the chip design template, the decision tree data structure.

20. The non-transitory computer readable medium according to claim 18, wherein the RL agent is trained via a proximal policy optimization (PPO) algorithm configured to maximize an expected cumulative reward derived from an OPC loss, wherein the OPC loss quantifies alignment between simulated, post-lithography wafer patterns and the design patterns included in the chip design template, the simulated, post-lithography wafer patterns produced by a simulation utilizing a photomask designed using OPC actions generated by the RL agent during training, and
wherein the OPC loss is computed based on (i) a Euclidean distance metric, (ii) an edge placement error (EPE), and (iii) a process variation band.
